(19) United States
(12) Patent Application Publication
(10) Pub. No.: US 2003/0228071 A1
(43) Pub. Date: Dec. 11, 2003

(54) Parallel resampling of image data

(75) Inventors: Joaquin Tarraga Gimenez, Lausanne (CH); Benoit Gennart, Lausanne (CH)

Correspondence Address: John F. Nethery, SONNENSCHEIN NATH & ROSENTHAL, Wacker Drive Station, Sears Tower, P.O. Box #061080, Chicago, IL, 60606-1080, US

(73) Assignee: AXS TECHNOLOGIES

(21) Appl. No.: 10/163,243

(22) Filed: Jun. 5, 2002

(51) Int. Cl. G06T 1/20; G06T 3/40

(52) U.S. Cl. 382/298; 382/304; 345/667

(57) ABSTRACT

A resampling technique selects positions for resampled pixels in a resampled tile such that adjacent tiles need not be retrieved to obtain a value for the resampled pixel. Thus, the resampled pixel does not depend on source pixels in adjacent source tiles. As a result, the resampling technique accelerates image resampling by localizing computation of resampled pixels to the source tile that contains the resampled pixel. In an alternate embodiment, the resampling technique combines separately computed partial results for a resampled pixel rather than incurring data transfer and synchronization overhead for transferring whole source tiles.

### FIELD OF THE INVENTION

This invention relates to image processing. In particular, this invention relates to resampling of image data in a parallel processing environment.

### BACKGROUND OF THE INVENTION

Rapid growth in computer processing power coupled with enormous increases in the capacity of data storage devices have enabled the widespread use of complex images in innumerable applications. In many instances, the images need to be resized to fit an appropriate view on a display, to reduce the amount of data for faster transmission or display, and the like. Typically, it is desirable to resize the image by resampling in order to provide an accurate approximation to the original image, but smaller in size, as opposed to simply cropping an image and throwing away data.

Resampling an image from a source image to a target (smaller) image preferably occurs as quickly as possible. However, resampling an image is a computationally intensive operation. For example, applying a bilinear resampling technique to a two dimensional source image requires computation of each pixel, r, in the target image according to:

r=(1−a)(1−b)sₜₗ+(a)(1−b)sₜᵣ+(1−a)(b)s_{bl}+(a)(b)s_{br}

where sₜₗ, sₜₗ, s_{bl}, and s_{br} are the values of the closest top-left, top-right, bottom-left, and bottom-right neighbors of the pixel r in the source image, and ‘a’ and ‘b’ are the relative horizontal and vertical positions of the pixel r with respect to a grid cell in the source image bounded by sₜₗ, sₜₗ, s_{bl}, and s_{br} (0<=a<1, 0 <=b<1).

One prior approach to enhancing resampling speed required dividing the source image into tiles, distributing the tiles to separate processors, resizing the tiles on the multiple processors, and merging the results to form the target image. However, any given processor was required to obtain the pixel data from neighboring tiles in order to correctly compute a target image pixel in its own tile. As a result, this attempt to enhance resampling speed suffered not only from data transfer delays as processors transferred tiles to and from other processors, but also from synchronization delays arising from each processor monitoring for the receipt of all the tiles that the processor needed before the processor could resample its tile.

Therefore, a need has long existed for methods and apparatus that overcome the problems noted above and others previously experienced.

### SUMMARY OF THE INVENTION

Methods and systems consistent with the present invention provide a resampling technique that executes more quickly (while still providing excellent results) than prior resampling techniques. The resampling technique may be implemented in a parallel processing environment without disadvantages arising from data transfer delays and synchronization overhead. Thus, the resampling technique may be used to provide resampled images much more quickly to serve many more requests over a given period of time than prior resampling techniques.

According to one aspect of the present invention, such methods and systems include choosing positions for resampled pixels in a resampled tile such that adjacent tiles need not be retrieved to obtain a value for the resampled pixel. In other words, the resampled pixel does not depend on source pixels in adjacent source tiles. Thus, the methods and systems accelerate image resampling by localizing the computation of resampled pixels to the source tile that contains the resampled pixel.

Methods and systems consistent with the present invention overcome the shortcomings of the related art, for example, by eliminating data transfer delays and synchronization overhead. Thus, a processor or parallel computing system need not spend time transmitting and receiving adjacent source tiles, nor determining whether a full set of adjacent source tiles has been received. Rather, the processor may proceed to resample a source tile without incurring that overhead conventionally associated with resampling.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 illustrates an example of the properties of discrete line approximations that are used by a resampling program running in the data processing system shown in FIG. 1.

FIG. 3 shows an example of resampled tiles based on source tiles, as determined by the resampling program running in the data processing system shown in FIG. 1.

FIG. 4 depicts a flow diagram showing processing performed by resampling program running in the data processing system shown in FIG. 1 in order to resample source tiles.

FIG. 5 shows a second example of resampled tiles based on source tiles, as determined by the resampling program running in the data processing system shown in FIG. 1.

FIG. 6 depicts a flow diagram showing processing performed by resampling program running in the data processing system shown in FIG. 1 in order to resample source tiles according to the second example shown in FIG. 5.

FIG. 7 depicts an expanded view of the source tile B1 shown in FIG. 3.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

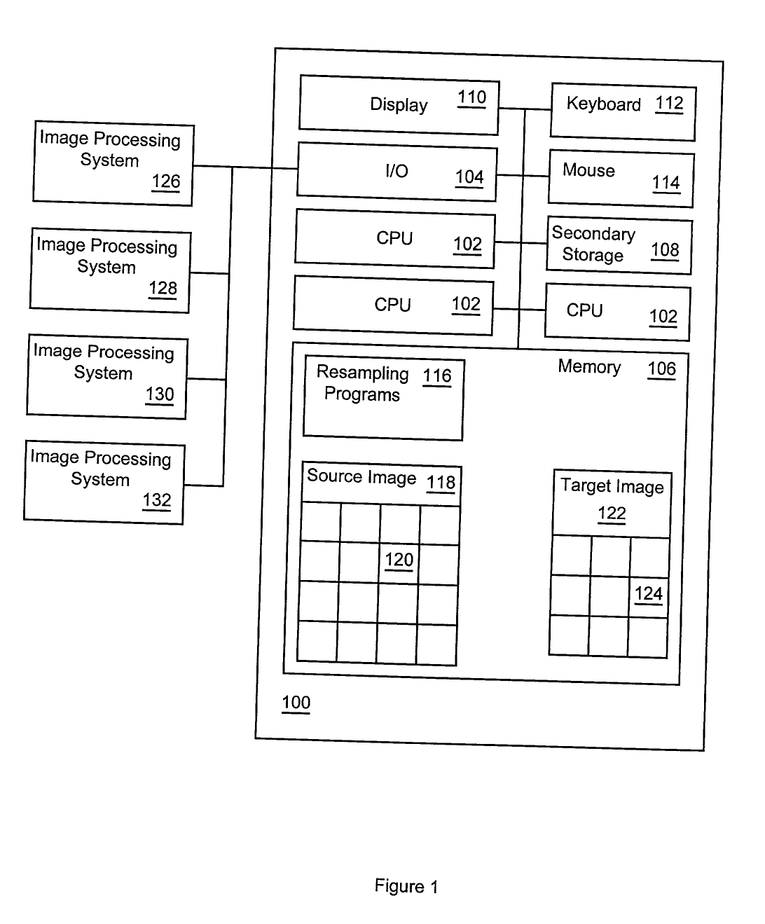

FIG. 1 depicts a block diagram of an image processing system 100 suitable for practicing methods and implementing systems consistent with the present invention. The image processing system 100 comprises at least one central processing unit (CPU) 102 (three are illustrated), an input output I/O unit 104 (e.g., for a network connection), a memory 106, one or more secondary storage devices 108, and a video display 110. The data processing system 100 may further include input devices such as a keyboard 112 or a mouse 114. The memory 106 stores one or more instances of a resampling program 116 for the processors 102 that resample a source image 118 divided into source tiles 120 to form the target image 122 from resampled tiles 124.

The source tiles 120 are Xsize pixels wide, and Ysize pixels long. The number of source tiles 120, and their width and length, may vary considerably between source images 118. As one example, Xsize and Ysize may both be 10 or more in order to form source tiles 120 with more than 100 pixels.

The image processing system 100 may connect to one or more separate image processing system 126-132. For example, the I/O unit 104 may include a WAN/LAN or Internet network adapter to support communications from the image processing system 126 locally or remotely. Thus, the image processing system 126 may take part in resampling the source image 118 by independently resampling the source tiles 120 as will described in more detail below. In general, the resampling techniques may run in parallel on any of the multiple processors 102 or separate image processing systems 126, and intermediate results (e.g., resampled tiles) may be combined in whole or in part on any of the multiple processors 102 or separate image processing systems 126.

The image processing systems 126-132 may be implemented in the same manner as the image processing 100. Furthermore, the image processing systems 126-132 may also help resample portions of the source image 118. Thus, the image resampling may not only take place in a multiple-processor shared-memory architecture (e.g., as shown by the image processing system 100), but also in a distributed memory architecture (e.g., including the image processing systems 100 and 126-132).

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of the image processing system 100 are described, one skilled in the art will appreciate that an image processing system suitable for use with methods and systems consistent with the present invention may contain additional or different components.

The resampling program 116 determines for each resampled tile 124 a number, h, of resampled pixels in a horizontal direction and a number, v, of resampled pixels in a vertical direction. As will be explained in greater detail below, the resampling program 116 determines the numbers h and v of resampled pixels, and chooses their positions by uniformly distributing the resampled pixels, such that a resampled pixel depends only on source pixels in the source tile in which any given resample pixel is positioned.

In making the determination of the numbers h and v, the resampling program 116 determines plateau lengths of a discrete line approximation D(a, b). The parameter ‘a’ is less than the parameter ‘b’, and ‘a’ and ‘b’ are mutually prime. To draw the D(a, b) discrete line, a line counter is initialized at zero, and a unit square pixel with bottom-left corner is placed at the origin (0,0). Next, the following steps are repeated: (1) The parameter ‘a’ is added to the line counter, and 1 is added to the pixel X-coordinate; (2) If the line counter is larger than the parameter ‘b’, then the line counter is replaced by (line counter mod b) and 1 is added to the pixel Y-coordinate; and (3) A pixel is added at the new X-coordinate and Y-coordinate. Table 1 shows the value of the line counter and pixel-coordinates for several steps in the D(2,5) discrete line.

TABLE 1

| line | | | | | | | | | |
|---|---|---|---|---|---|---|---|---|---|
| count- | | | | | | | | | |
| er | 0 | 2 | 4 | 1 | 3 | 0 | 2 | 4 | 1 |
| pixel- | (0,0) | (1,0) | (2,0) | (3,1) | (4,1) | (5,2) | (6,2) | (7,2) | (8,3) |
| coord- | | | | | | | | | |
| inate | | | | | | | | | |

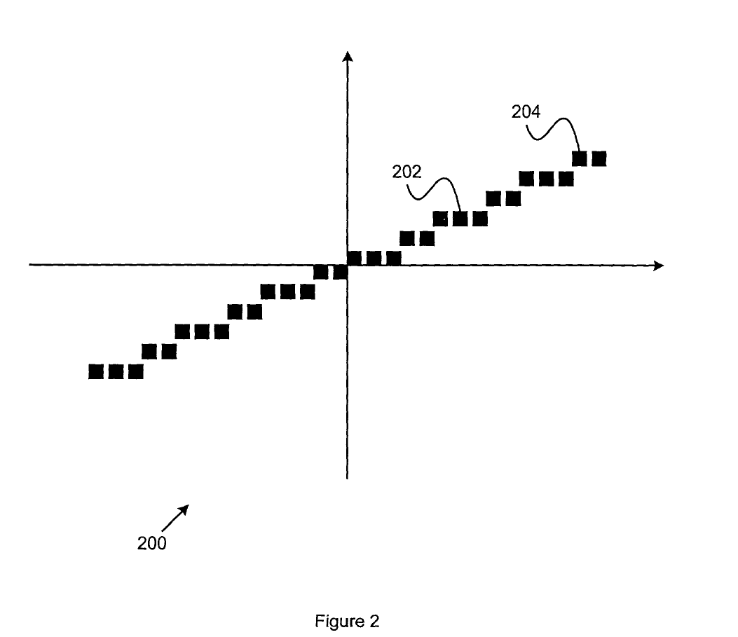

FIG. 2 shows a portion of the D(2,5) discrete line 200. The discrete line 200 includes plateaus, two of which are designated 202 and 204. A plateau is a set of contiguous pixels where the Y-coordinate does not change. The first plateau has a length of three pixels, and the second plateau has a length of two pixels. In general, under the assumptions given above, a discrete line D(a, b) will have plateau lengths (a div b) or (a div b)+1.

Note that the resampling program 116 will create the target image 122 based on a preselected resampling ratio (alpha/beta), with alpha and beta mutually prime. The resampling ratio is the fractional size of the target image 122 compared to the source image 118. For example, resampling a 1000×1000 pixel image to a 600×600 pixel image corresponds to a resampling ratio of 600/1000=3/5.

The resampling program 116 determines the number, h, of resampled pixels in the horizontal direction in accordance with the plateau lengths of the discrete line approximation D(beta, alpha*Xsize). Similarly, the number, v, of resampled pixels in the vertical direction is given by the plateau lengths of the discrete line approximation D(beta, alpha*Ysize). Each new plateau gives the number of pixels h or v in the next resampled tile 124. Because the plateau lengths vary, so do the number of pixels, h and v, between resampled tiles 124.

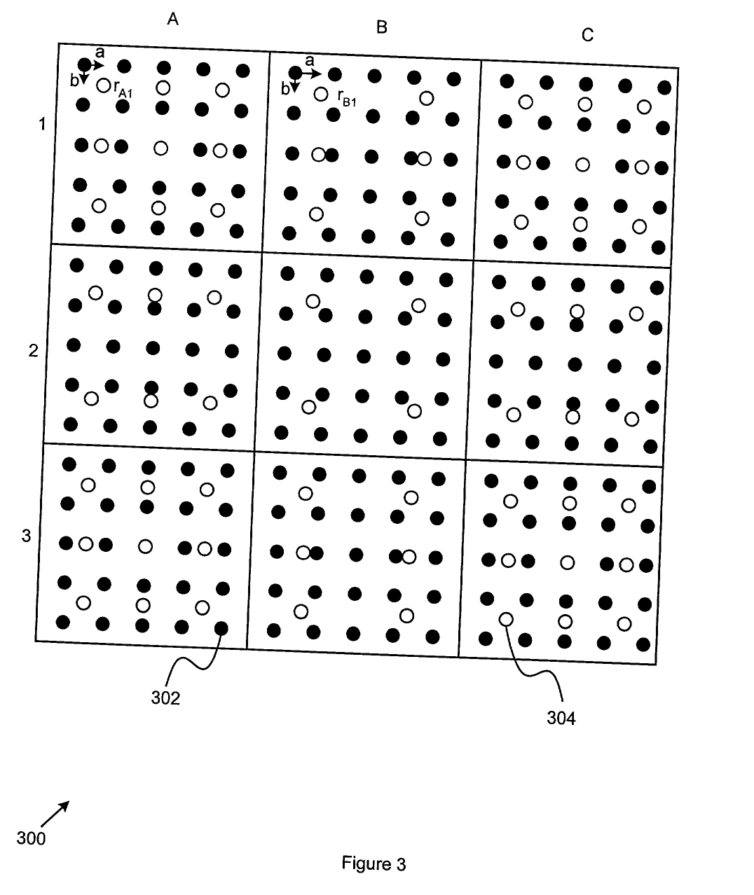

For example, FIG. 3 illustrates a section 300 of a source image broken into source tiles A1-C3. Solid black circles indicate source pixels 302. Open circles represent resampled pixels 304 based on the source pixels 302. For the source tiles 302, Xsize=5 and Ysize=5. The resampling ratio is (1/2) (i.e., for every 10 source pixels, there are 5 resampled pixels).

Since Xsize=Ysize=5, the number v=the number h=the plateau lengths of the discrete line D(2,1*5)=D(2,5). As shown above, the discrete line D(2,5) yields plateau lengths that vary between 3 pixels and 2 pixels. As a result, moving horizontally from tile to tile changes the number of horizontal resampled pixels, h, from 3 to 2 to 3, and so on. Similarly, moving vertically from tile to tile changes the number of vertical resampled pixels, v, from 3 to 2 to 3, and so on. Thus, the number, h, for the tiles A1, A2, A3, C1, C2, and C3 is 3 and the number, h, for the tiles B1, B2, and B3 is 2. The number, v, for the tiles A1, B1, C1, A3, B3, and C3 is 3 and the number, v, for the tiles A2, B2, and C2 is 2.

In a given source tile (e.g., A1), the resampling program 116 chooses positions for the resampled pixels 304 relative to the source pixels 302 such that no source pixels in adjacent source tiles (e.g., B1 or A2) contribute to the resampled pixels. The process may be conceptualized by dividing the source tile into v horizontal segments and h vertical segments. The horizontal segment and vertical segments intersect to form a grid of h*v cells. A resampled pixel is placed at the center of each cell.

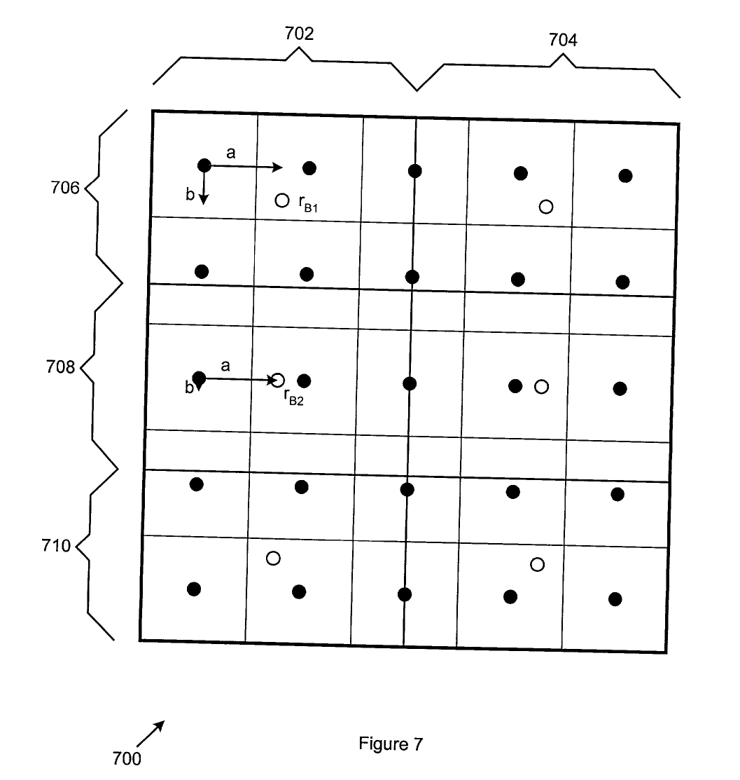

Turning briefly to FIG. 7, for example, the figure provides an expanded view 700 of the source tile B1. Again, solid black circles indicate source pixels while open circles represent resampled pixels based on the source pixels. The solid black circles represent a 5×5 source tile, while the open circles represent a 2×3 resampled tile.

The source pixels are centered at the grid coordinates shown below in Table 2:

TABLE 2

| | | | | |
|---|---|---|---|---|
| (2.5, 2.5) | (7.5, 2.5) | (12.5, 2.5) | (17.5, 2.5) | (22.5, 2.5) |
| (2.5, 7.5) | (7.5, 7.5) | (12.5, 7.5) | 17.5, 7.5) | (22.5, 7.5) |
| (2.5, 12.5) | (7.5, 12.5) | (12.5, 12.5) | (17.5, 12.5) | (22.5, 12.5) |
| (2.5, 17.5) | (7.5, 17.5) | (12.5, 17.5) | (17.5, 17.5) | (22.5, 17.5) |
| (2.5, 22.5) | (7.5, 22.5) | (12.5, 22.5) | (17.5, 22.5) | (22.5, 22.5) |

The resampled pixels are centered at the coordinates shown below in Table 3:

TABLE 3

| | |
|---|---|
| (6.25, 4.1666) | (18.75, 4.1666) |
| (6.25, 12.5) | (18.75, 12.5) |
| (6.25, 18.833) | (18.75, 18.833) |

Because the number h=2, the source tile B1 is conceptually divided into two vertical segments 702 and 704. Because the number v=3, the source tile B1 is conceptually divided into three horizontal segments 706, 708, and 710. Resampled pixels are placed centrally with regard to each horizontal segment 706-710 and each vertical segment 702-704 (i.e., in the center of each of the six cells formed by the horizontal and vertical segments 702-710).

For the resampled pixel r_{B1}, for example, the parameters ‘a’ and ‘b’ are ((6.25−2.5)/5, (4.166−2.5)/5)=(0.75,0.333). For the resampled pixel r_{B2}, the parameters ‘a’ and ‘b’ are (0.75,0).

Next, the resampling program 116 determines each resampled pixel 304 based on the source pixels 302 that contribute to that resampled pixel. Due to the distribution of resampled pixels 304 explained above, only source pixels in the same source tile as the resampled pixel 304 need to be considered. In one embodiment, the resampling program 116 determines a value, r, for each resampled pixel, in one embodiment according to:

r=(1−a)(1−b)sₜₗ+(a)(1−b)sₜᵣ+(1−a)(b)s_{bl}+(a)(b)s_{br},

where sₜₗ, sₜₗ, s_{bl}, and s_{br} are the values of the closest top-left, top-right, bottom-left, and bottom-right neighbors of the resampled pixel in the source tile, and ‘a’ and ‘b’ are the relative horizontal and vertical positions of the resampled pixel with respect to the neighbors.

If a resampled pixel is aligned vertically with the source pixels, the four neighboring pixels are considered to be the two aligned source pixels and their two right neighbors. If the resampled pixel is aligned horizontally with the source pixels, the four neighboring pixels are considered to be the two aligned source pixels and their two bottom neighbors. Finally, if a resampled pixel is aligned exactly with a source pixel, the four neighboring pixels are considered to the aligned pixel, its right neighbor, its bottom neighbors and its bottom-right neighbor.

Note that choosing the number and positions for the resampled pixels as described above eliminates the need to retrieve adjacent source tiles to arrive at a value for a resampled pixel. In other words, the resampled pixel does not depend on source pixels in adjacent source tiles. Thus, image resampling is accelerated by avoiding data transfer delays and synchronization overhead.

The resampled pixels form resampled tiles. Once the resampled tiles are determined, the resampling program 116 (or another application) may form the complete resampled image by merging the resampled tiles. As noted above, one or more independent processors or image processing systems may have helped to determine a full set of resampled tiles that make up a resampled image.

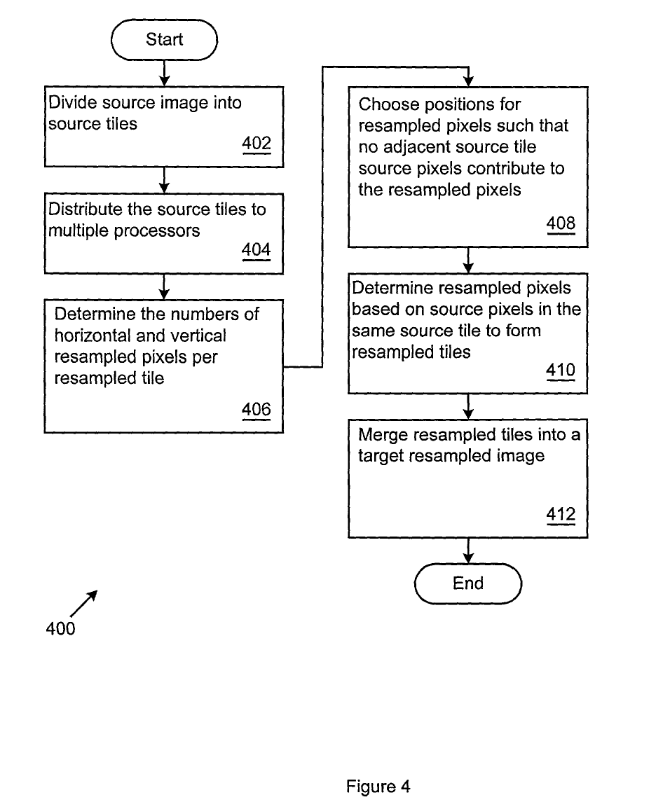

Turning next to FIG. 4, that figure shows a flow diagram 400 of the processing steps performed in resampling a source image. Initially, a source image is partitioned into multiple source tiles of any preselected size. (Step 402). The source tiles are then distributed to multiple processors. (Step 404). Steps 402 and 404 need not be performed by the resampling program 116. Rather, an operating system or an application program may divide the source image and distribute it to the processors.

Thus, the resampling program 116 may begin by reading the source tiles from one or more secondary storage devices. Additionally, additional speed may be achieved by having the resampling program 116 overlap source tile retrieval with resampled tile computation. In other words, as one or more processors 102 are resampling a given source tile, the secondary storage devices 108 may be concurrently retrieving subsequent source tiles.

Next, the resampling program 116 determines the number, h, and number v, of horizontal and vertical resampled pixels per resampled tile. (Step 406). To that end, the resampling program 116 may use the plateau lengths of the discrete line approximation D(a, b) as noted above. Having determined the numbers h and v, the resampling program 116 chooses positions for the resampled pixels. (Step 408). The positions are selected such that a given resampled pixel does not depend on source pixels in any adjacent source tiles.

Once the positions for the resampled pixels are established, the resampling program 116 determines the resampled pixels. (Step 410). As noted above, because the resampled pixels do not depend on source pixels in adjacent tiles, the resampling program need not spend time or resources transferring source tile data between processors, synchronizing reception of the source tiles, and the like. The resampled pixels form resampled tiles.

Once the resampled tiles are available, the resampling program 116 (or another application) may then merge the resampled tiles into a resampled image. (Step 412). For example, the resampled pixels in each resampled tile may be copied in the proper order into a single file that stores the resampled image.

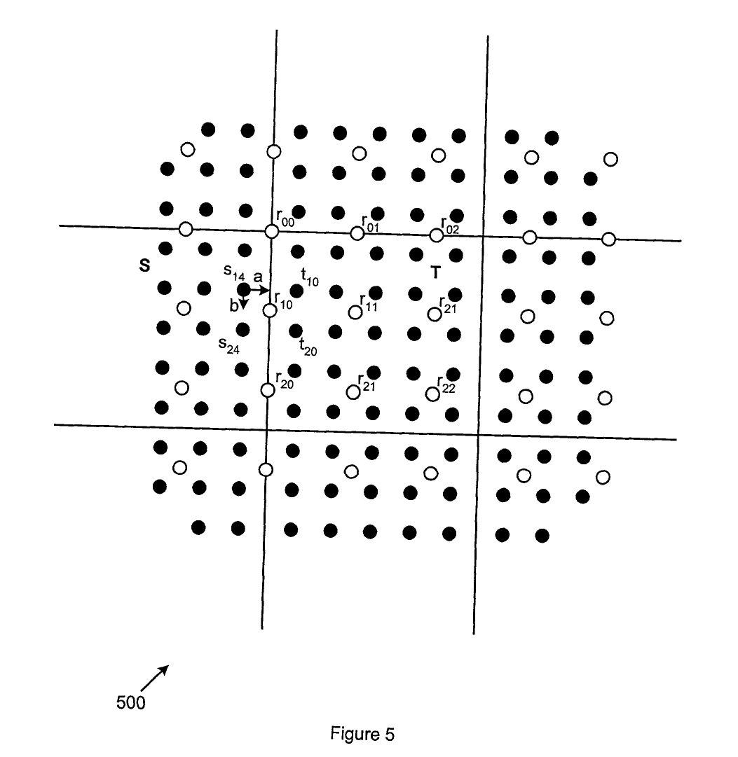

In an alternate embodiment, the resampling program 116 determines resampled pixels as shown in FIG. 5. FIG. 5 illustrates a source tile S and a source tile T, source pixels s₁₄ and s₂₄ in the source tile S, and source pixels t₁₀ and t₂₀ in the source tile T. Also shown are resampled pixels r₀₀, r₀₁, r₀₂, r₁₀, r₁₁, r₁₂, r₂₀, r₂₁, and r₂₂.

Note that no special processing has been performed to position the resampled pixels such they depend only on source pixels in a single source tile. As a result, some resampled pixels (in this example, r₀₀, r₀₁, r₀₂, r₁₀, and r₂₀) are border pixels. In other words, resampled pixels r₀₀, r₀₁, r₀₂, r₁₀, and r₂₀ depend on source pixels in adjacent source tiles. As one specific example, the resampled pixel r₁₀ depends on source pixels in the source tile S (namely s₁₄ and s₂₄) and source pixels in the source tile T (namely t₁₀ and t₂₀).

The resampling program 116, rather than incurring the inefficiencies associated with requesting and receiving adjacent source tiles from other processors or image processing systems, instead computes partial results (for example, partial bi-linear interpolation results) for each border pixel. With regard to the resampled pixel r₁₀, for example, the resampling program 116 running on the source tile T processor determines a first partial result according to:

r^{T}₁₀=(a)(1−b)t₁₀+(a)(b)t₂₀

The first partial result gives the contribution to the resampled pixel r₁₀ from the source tile T. Similarly, the source tile S processor computes a second partial result for the resampled pixel r₁₀ according to:

r^{s}₁₀=(1−a)(1−b)s₁₄+(1−a)(b)s₂₄

The resampling program 116 running on the source tile T processor may then request and obtain the second partial result from the source tile S processor, and combine the partial results to obtain the resampled pixel. Alternatively, the partial results may be separately stored until an application (as examples, an image editor, or the resampling program 116 itself) merges the resampled tiles to form the resampled image.

At that time, the application obtains the data for the resampled pixels, whether completely determined, or partially determined by each processor or image processing system. With respect to r₁₀, for example, the application combines the first partial result and the second partial result to obtain the resampled pixel. Specifically, the application may add the first partial result to the second partial result.

Note that under the approach described above with respect to FIG. 5, the resampling program 116 avoids the overhead that arises from requesting and receiving adjacent source tiles from other processors or image processing systems. Instead, partial results are determined and stored until needed.

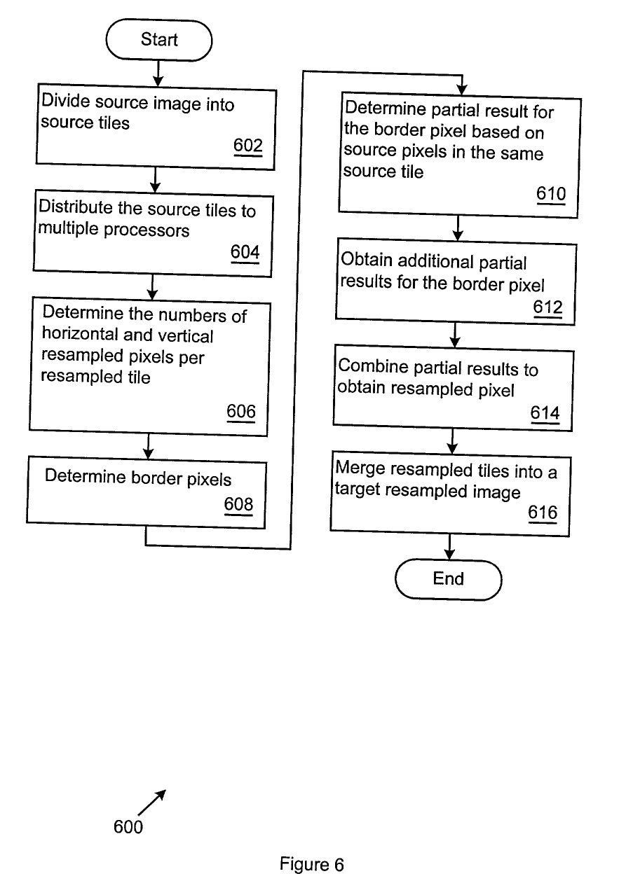

Turning next to FIG. 6, that figure shows a flow diagram 600 of the processing steps performed in resampling a source image according to the second approach discussed above. Initially, a source image is partitioned into multiple source tiles of any preselected size. (Step 602). The source tiles are then distributed to multiple processors. (Step 604). Steps 602 and 604 need not be performed by the resampling program 116. Rather, an operating system itself, or another application program may be used to divide the source image and distribute it to the processors.

Thus, as was explained above with regard to FIG. 4, the resampling program 116 may begin by reading the source tiles from one or more secondary storage devices and perform concurrent resampling and source tile retrieval for increased speed.

Next, the resampling program 116 determines the number of horizontal and vertical resampled pixels per resampled tile. (Step 606). For example, the resampling program 116 may determine the number and position of resampled pixels based on a conventional bi-linear interpolation technique. The resampling program 116 then determines which resampled pixels are border pixels. (Step 608). In other words, the resampling program 116 determines which resampled pixels depend on source pixels in adjacent source tiles.

For those border pixels, the resampling program 116 determines a first partial result that depends on the source pixels in the same source tile that the resampling program 116 is currently resampling. (Step 610). Alternatively, the resampling program 116 may copy the source tile into the middle of a black image (i.e., with pixel values=0) and compute the resampled tile based on the data in the larger black image. At the border, the black pixels outside the source tile will not contribute to the bi-linear interpolation computation, thereby achieving the same result as computing the partial result. Subsequently, the resampling program 116 (or another application program) may obtain any other partial results for the border pixel that were determined by different processors or image processing systems. (Step 612). The application may then combine the partial results to determine the resampled pixel. (Step 614). With all of the resampled pixels determined, the application may then merge all the resampled pixels into a single resampled image. (Step 616).

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in an image processing system for resampling a source tile of an image divided into multiple source tiles, each source tile comprising source pixels, the method comprising the steps of:
choosing a position for each resampled pixel relative to the source pixels in the source tile such that no source pixels in adjacent source tiles contribute to that resampled pixel; and
determining each resampled pixel based on the source pixels in the source tile that contribute to that resampled pixel to obtain a resampled tile.

2. The method of claim 1, further comprising the steps of:
concurrently with resampling the source tile, retrieving a subsequent source tile for resampling; and
merging a plurality of resampled tiles into a target image.

3. The method of claim 1, further comprising the step of determining for each source tile a number, h, of resampled pixels in a horizontal direction, and a number, v, of resampled pixels in a vertical direction.

4. The method of claim 3, wherein the step of choosing a position comprises choosing a horizontal position and a vertical position by uniformly distributing the number, h, of resampled pixels horizontally in the source tile and uniformly distributing the number, v, of resampled pixels vertically in the source tile.

5. The method of claim 3, wherein the step of determining the number, h, and the number, v, further comprises determining the number, h, and the number, v, according to a preselected resampling ratio (alpha/beta).

6. The method of claim 5, wherein the step of determining further comprises determining the number h, and the number v, according to a plateau length of a discrete line approximation D(a, b).

7. The method of claim 5, wherein the step of determining further comprises determining the number h, and the number v, according to a first and a second plateau length of a discrete line approximation D(a, b).

8. The method of claim 6, wherein each source tile comprises Xsize pixels horizontally and D(a, b)=D(beta, alpha*Xsize) for determining the number h.

9. The method of claim 6, wherein each source tile comprises Ysize pixels vertically and D(a, b)=D(beta, alpha*Ysize) for determining the number v.

10. A machine-readable medium storing instructions that cause a data processing system to perform a method for resampling a source image, the method comprising the steps of:
retrieving source tiles of a source image divided into multiple source tiles;
for each source tile, resampling that source tile by:
determining a position for each resampled pixel relative to the source pixels in that source tile such that only source pixels in that source tile contribute to that resampled pixel;
computing each resampled pixel based on the source pixels in that source tile that contribute to that resampled pixel to obtain resampled tiles.

11. The machine-readable medium of claim 10, further comprising the step of merging the resampled tiles into a target image.

12. The machine-readable medium of claim 10, further comprising the step of determining for each source tile a number, h, of resampled pixels in a horizontal direction, and a number, v, of resampled pixels in a vertical direction.

13. The machine-readable medium of claim 12, wherein the step of determining further comprises determining the number h, and the number v, according to a plateau length of a discrete line approximation D(a, b).

14. The machine-readable medium of claim 12, wherein the number h, and the number v, vary according to a first and a second plateau length of a discrete line approximation D(a, b).

15. The machine-readable medium of claim 13, wherein each source tile comprises Xsize pixels horizontally and D(a, b)=D(beta, alpha*Xsize) for determining the number h, according to a preselected resampling ratio (alpha/beta).

16. The machine-readable medium of claim 13, wherein each source tile comprises Ysize pixels vertically and D(a, b)=D(beta, alpha*Ysize) for determining the number v, according to a preselected resampling ratio (alpha/beta).

17. An image processing system comprising:
a memory storing an image resampling program, the resampling program determining a resampled tile comprisng resampled pixels based on a source tile of a source image, the resampling program choosing a position for each resampled pixel relative to source pixels in the source tile such that no source pixels in an adjacent source tile contribute to the resampled pixel, the resampling program further determining each resampled pixel based on the source pixels in the source tile that contribute to the resampled pixel; and
a processor that runs the image resampling program.

18. The image processing system of claim 17, wherein the resampling program determines each resampled pixel based on a bi-linear linterpolation of the source pixels that contribute to the resampled pixel.

19. The image processing system of claim 17, wherein the resampling program further determines a number, h, of pixels horizontally in the resampled tile and determines a number, v, of pixels vertically in the resampled tile.

20. The image processing system of claim 19, wherein the number, h, and the number, v, are determined in accordance with a preselected resampling ratio (alpha/beta).

21. The image processing system of claim 20, wherein the source tile comprises Xsize pixels horizontally and Ysize pixels vertically, and wherein the number, h, is determined by a plataeu length of a discrete line approximation D(beta, alpha*Xsize), and wherein the number, v, is determined by a plateau length of a discrete line approximation D(beta, alpha*Ysize).

22. The image processing system of claim 21, wherein Xsize is not equal to Ysize.

23. The image processing system of claim 20, wherein the source tile comprises Xsize pixels horizontally and Ysize pixels vertically, and wherein the number, h, varies in accordance with plataeu lengths of a discrete line approximation D(beta, alpha*Xsize), and wherein the number, v, varies in accordance with plateau lengths of a discrete line approximation D(beta, alpha* Ysize).

24. The image processing system of claim 19, wherein the step of choosing comprises dividing the source tile into h vertical segments and choosing positions horizontally centered in each of the h vertical segments.

25. The image processing system of claim 19, wherein the step of choosing comprises dividing the source tile into v horizontal segments and choosing positions vertically centered in each of the v horizontal segments.

26. A method in an image processing system for resampling a source tile of an image divided into multiple source tiles, each source tile comprising source pixels, the method comprising the steps of:
retrieving a source tile comprising source pixels;
choosing positions for resampled pixels relative to the source pixels;
determining when a resampled pixel is a border pixel that depends on a source pixel in an adjacent tile, and in response, determining a first partial result for the border pixel based on source pixels in the source tile;
obtaining a second partial result for the border pixel based on source pixels in the adjacent tile; and
combining the first partial result and the second partial result to obtain the resampled pixel.

27. The method of claim 26, wherein the step of determining a first partial result comprises determining by a first processor, and wherein the step of obtaining comprises obtaining the second partial result determined by a second processor.

28. The method of claim 26, wherein the step of combining comprises adding.

29. The method of claim 28, wherein the first partial result is a first bi-linear interpolation result, and wherein the second partial result is a second bi-linear interpolation result.

30. The method of claim 26, further comprising the steps of:
concurrently with resampling the source tile, retrieving a subsequent source tile for resampling; and
merging a plurality of resampled tiles into a target image.

31. A machine-readable medium storing instructions that cause an image processing system to perform a method for resampling a source image, the method comprising the steps of:
retrieving a source tile comprising source pixels;
choosing positions for resampled pixels relative to the source pixels;
determining when a resampled pixel is a border pixel that depends on a source pixel in an adjacent tile, and in response, determining a first partial result for the border pixel based on source pixels in the source tile;
obtaining a second partial result for the border pixel based on source pixels in the adjacent tile; and
combining the first partial result and the second partial result to obtain the resampled pixel.

32. The machine-readable medium of claim 31, wherein the step of determining a first partial result comprises determining by a first processor, and wherein the step of obtaining comprises obtaining the second partial result determined by a second processor.

33. The machine-readable medium of claim 31, wherein the first partial result is a first bi-linear interpolation result, and wherein the second partial result is a second bi-linear interpolation result.

34. An image processing system comprising:
a memory storing an image resampling program, the resampling program determining a resampled tile comprisng resampled pixels based on a source tile of a source image, the resampling program choosing a position for each resampled pixel relative to source pixels in the source tile, the resampling program further determining when a resampled pixel is a border pixel that depends on a source pixel in an adjacent tile, and in response, determining a first partial result for the border pixel based on source pixels in the source tile, obtaining a second partial result for the border pixel based on source pixels in the adjacent tile, and combining the first partial result and the second partial result to obtain the resampled pixel; and
a processor that runs the image resampling program.

35. The image processing system of claim 34, wherein the first partial result is determined by a first processor in the image processing system, and wherein the second partial result is determined by a second processor in a different data image processing system.

36. The image processing system of claim 34, wherein the first partial result is a first bi-linear interpolation result, and wherein the second partial result is a second bi-linear interpolation result.

37. The image processing system of claim 36, wherein the resampling program combines the first partial result and the second partial result by adding the first partial result and the second partial result.
